(19) United States
(12) Patent Application Publication
(10) Pub. No.: US 2009/0262301 A1
(43) Pub. Date: Oct. 22, 2009

(54) Toric Contact Lenses Having Selected Spherical Aberration Characteristics

(76) Inventors: Jennifer Zuba, Rochester, NY (US); Timothy Green, Rochester, NY (US)

Correspondence Address: Bausch & Lomb Incorporated, One Bausch & Lomb Place, Rochester, NY, 14604-2701, US

(21) Appl. No.: 12/423,266

(22) Filed: Apr. 14, 2009

Related U.S. Application Data
(60) Provisional application No. 61/046,914, filed on Apr. 22, 2008.

(51) Int. Cl. G02C 7/04

(52) U.S. Cl. 351/160 R

(57) ABSTRACT

A contact lens, comprising a first surface and a toric second surface. The toric surface has a first meridian and a second meridian, and the toric surface has a first aspheric component in the first meridian. At least one of the first surface and the second meridian of the second surface has a second aspheric component, such that spherical aberration in the first meridian is within 0.1 microns (um) of being equal to the spherical aberration in the second meridian.

### FIELD OF INVENTION

The present invention relates to toric contact lenses, and more particularly to toric contact lenses having selected spherical aberration characteristics.

### BACKGROUND OF THE INVENTION

Contact lenses having a toric surface in an optical zone (commonly referred to as “toric contact lenses”) are used to correct refractive abnormalities of the eye associated with astigmatism. Since astigmatism that requires correction is usually associated with other refractive abnormalities, such as myopia (nearsightedness) or hypermetropia (farsightedness), toric contact lenses are generally prescribed with a spherical power to correct myopic astigmatism or hypermetropic astigmatism.

In toric contact lenses, the optical zone provides cylindrical correction to compensate for astigmatism. The resulting optical zone has a sphere power meridian and a cylinder power meridian.

The orientation of each of the above meridians is best understood with reference to conventional contact lens prescriptions. In a prescription −3.00/-1.25, the sphere power meridian is the meridian having a power equal to −3.00 diopters and the cylinder power meridian is the meridian having a power equal to −4.25 diopters. And in a prescription +3.00/−1.25, the sphere power meridian is the meridian having a power equal to −3.00 diopters and the cylinder power meridian is the meridian having a power equal to +1.75 diopters.

Toric contact lenses are manufactured with a selected orientation of the sphere power meridian of the toric surface relative to a horizontal meridian as determined by a corresponding stabilization structure (e.g., a contact lens prism ballast). Said orientation is referred to herein as an angular offset (hereinafter referred to simply as “offset”). For example, this relationship may be expressed as a number of degrees that the sphere power meridian is angularly displaced from a horizontal meridian of the lens as determined by the ballast. Toric contact lens prescriptions specify offset, with toric lenses generally being offered in 5 or 10-degree increments ranging from 0 degrees to 180 degrees.

In summary, to define the optical correction, a prescription for a toric contact lens will typically specify a spherical power, a cylindrical correction and an offset. In addition, a contact lens prescription will specify an optical zone diameter, an overall lens diameter as well as various other fitting parameters. For example, in the case of contact lenses, a base curve may also be specified. A toric surface may be formed on either a posterior lens surface (to achieve a “back surface toric lens”) or an anterior lens surface (to form a “front surface toric lens”).

### SUMMARY

Toric contact lenses, like all contact lenses, are characterized by an amount of spherical aberration. However, toric contact lenses may have spherical aberration characteristics along a first meridian (e.g., one of the sphere power meridian or the cylinder power meridian) that are different than the spherical aberration characteristics along a second meridian (e.g., the other of the sphere power meridian and the cylinder power meridian).

The Applicants have determined that, by choosing multiple aspheric components, a contact lens can be made to have suitable spherical aberration characteristics (e.g., if a plane wave is input into the lens over a selected portion of the lens, in addition for providing correction for primary astigmatism, secondary astigmatism correction can also be attained).

In particular, the Applicants have determined that by choosing a different aspheric component in the sphere power meridian than in the cylinder power meridian, it is possible to achieve amounts of spherical aberration in the first meridian and in the second meridian that are equal to one another such that secondary astigmatism is reduced or obviated. In addition, in some embodiments, a lens is configured such that, in both the first meridian and in the second meridian, the lens has negative spherical aberration thereby compensating for positive aberration occurring in an average, healthy eye.

An aspect of the invention is directed to a contact lens, comprising a first optical surface; and a toric second optical surface having a first meridian and a second meridian, the toric surface having a first aspheric component in the first meridian, and at least one of the first surface and the second meridian of the second surface having a second aspheric component, such that spherical aberration in the first meridian is within 0.1 um of being equal to the spherical aberration in the second meridian.

In some embodiments, the spherical aberration in the first meridian and the spherical aberration in the second meridian are both between −0.35 to +0.35 um for light having a wavelength of 555 nm for an aperture of 6.0 mm.

In some embodiments, the spherical aberration in the first meridian and the spherical aberration in the second meridian are both between 0.00 to −0.30 um for light having a wavelength of 555 nm for an aperture of 6.0 mm.

In some embodiments, the spherical aberration in the first meridian and the spherical aberration in the second meridian are both between −0.05 to −0.25 um for light having a wavelength of 555 nm for an aperture of 6.0 mm.

In some embodiments, the spherical aberration in the first meridian and the spherical aberration are both negative for light having a wavelength of 555 nm for an aperture of 6.0 mm.

In some embodiments, the first meridian is a sphere power meridian and the second meridian is the cylinder power meridian. The second surface may be aspheric in the first meridian and in the second meridian. In some embodiments, the second surface is conic in the first meridian and in the second meridian. The first surface may be an anterior surface of the lens. In some embodiments, the first meridian and the second meridian are separated by 90 degrees.

As used herein the term “suitable amount of spherical aberration” means the lens is configured to achieve −0.35 to +0.35 microns (um) of spherical aberration in both a sphere power meridian and the cylinder power meridian for light having a wavelength of 555 nm for an optical zone having a diameter equal to 6.0 mm. In some embodiments, lenses are configured to achieve −0.00 to −0.30 um of spherical aberration in both meridians. In some embodiments, lenses are configured to achieve −0.05 to −0.25 um of spherical aberration in both meridians.

In some instances, a nominal, desired amount of spherical aberration in a given meridian is determined in part by the amount of optical power in the meridian. For example, for powers in a meridian ranging from −9 diopters to +6 diopters, an appropriate amount of spherical aberration may range from −0.25 um for −9.0 diopters to 0.10 um for +6.0 diopters. In the example, the magnitude of the nominal amount of spherical aberration varies approximately linearly for optical powers ranging from −9 diopters and +6 diopters. At any given power, the spherical aberration may be within a band −0.10 um to +0.10 um around the nominal spherical aberration value, due for example to manufacturing variation.

Dimensions described herein refer to dimensions of a finished lens. For example, the lenses are fully cured and, in embodiments comprising hydrophylic materials, the lenses are fully hydrated. It will be understood that contact lens parameters (e.g., optical power and spherical aberration) can be measured on-eye or free standing in a wet cell (e.g., in a vial filed with saline). Parameters specified herein refer to values measured free standing in a wet cell. Additionally, unless otherwise specified, a measured amount of spherical aberration refers to an amount corresponding to an aperture having a diameter of 6.0 mm.

In contact lens embodiments, the term “effective base curvature” is defined herein to mean the average radius of curvature of the posterior surface calculated over the entire posterior surface of a lens optic, including the periphery.

### BRIEF DESCRIPTION OF THE DRAWINGS

Illustrative, non-limiting embodiments of the present invention will be described by way of example with reference to the accompanying drawings, in which the same reference number is used to designate the same or similar components in different figures, and in which:

FIG. 1A is a plan view of a lens according to aspects of the present invention;

FIG. 1B is a schematic cross section of the lens of FIG. 1A taken along line 1B-1B; and

FIG. 1C is a second schematic cross section of the lens of FIG. 1A taken along line 1C-1C.

### DETAILED DESCRIPTION

According to aspects of the present invention, the lens comprises a first surface, and a toric second surface having a first meridian and a second meridian. The toric surface has a first aspheric component in the first meridian. At least one of the first surface and the second meridian of the second surface has a second aspheric component. The lens is configured such that, the spherical aberration in the first meridian and the spherical aberration in the second meridian are equal or substantially equal. Substantially equal spherical aberration values are within 0.1 microns, and in some embodiments within 0.05 microns.

In some embodiments, the lens is configured such that, in both the first meridian and in the second meridian, the lens has negative spherical aberration. In some embodiments, the first surface is circularly symmetric (also commonly referred to as an axisymmetric surface) and may have an aspheric shape. As was described above, lenses according to aspects of the present invention are configured to achieve between −0.35 to −0.35 microns (um) of spherical aberration in both a sphere power meridian and a cylinder power meridian for light having a wavelength of 555 nm. It will be appreciated that, in some embodiments, negative spherical aberration is selected to compensate for positive spherical aberration that is present in an average healthy human eye.

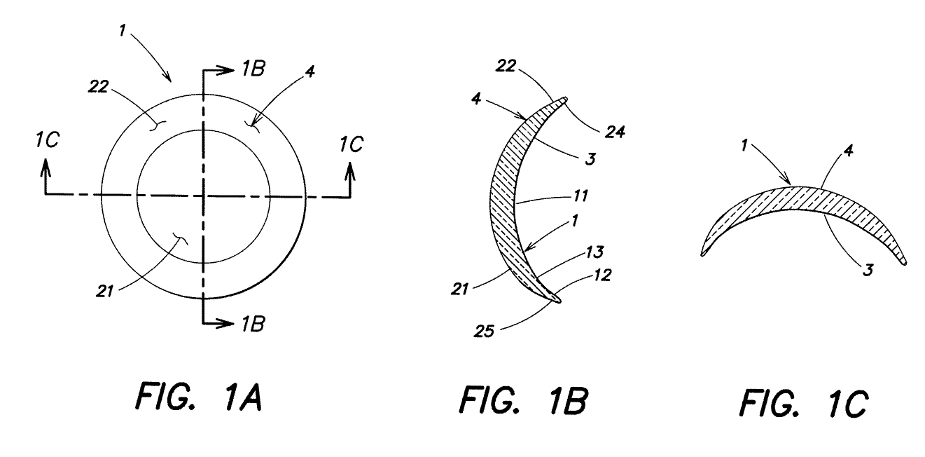

FIGS. 1A-1C are schematic illustrations of an example embodiment of a toric contact lens 1 according to aspects of the present invention. In the illustrated embodiment, a posterior central zone 11 (also referred to herein as a posterior optical zone) of posterior surface 3 is toric. The posterior central zone is the portion of the posterior surface that is optically corrected. Posterior surface 3 includes a peripheral zone 12 surrounding the central zone 11. In some embodiments, a blend zone is present between the central zone 11 and the peripheral zone. A blend zone is a non-optically corrected region that provides a more gradual transition from the central zone 11 to the peripheral zone 12 than would occur if the central zone were immediately adjacent to peripheral zone 12.

As illustrated in FIG. 1B, a central zone 21 of an anterior surface 4 of toric contact lens 1 has a spherical power and is optically corrected. Anterior surface 4 includes at least one peripheral zone 22 surrounding central zone 21. Central zone 21, in combination with central zone 11, is adapted to produce an image that is suitably corrected for vision. Such central zones are typically, but not necessarily, centered about an optical axis OA. In some embodiments, anterior surface 4 includes a blend zone between peripheral zone 22 surrounding the central zone 21.

In the illustrated embodiment, central zone 11 of posterior surface 3 of toric contact lens 1 is biconic. That is, the surface is constructed such that conic terms are selected in each of a sphere power meridian and a cylinder power meridian of the toric surface to achieve suitable spherical aberration in both meridians. The curvatures in the sphere power and cylinder power meridians are blended together in regions between the meridians to form a smooth surface using a conventional technique.

Lens 1 comprises an anterior surface, and a toric posterior surface having a first meridian (i.e., in the plane of FIG. 1B) and a second meridian (i.e., in the plane of FIG. 1C). In the illustrated embodiment, the lens has a first aspheric component in the first meridian, and the second meridian of the second surface has a second aspheric component. The lens is configured such that, in both the first meridian and in the second meridian, the lens has negative spherical aberration. Typically the first meridian and the second meridian are 90 degrees apart as shown in FIG. 1A; however, the first meridian and the second meridian may have any suitable angular separation.

For example, a toric surface may be selected to be conic in each of the sphere power meridian and a cylinder power meridian (i.e., a conic term and radius term as shown in Equation 1 are selected for each of the sphere power and the cylinder power meridians). Alternatively, a toric surface may be selected to be aspheric in each of the sphere power meridian and a cylinder power meridian (i.e., terms as shown in Equation 2 are selected for each of the sphere power and the cylinder power meridians). In other embodiments, any other suitable aspheric configuration for achieving suitable spherical aberration characteristics may be used.

$${z}_{conic} ( r ) = \frac{{cr}^{2}}{1 + \sqrt{1 - ( 1 + k ) {c}^{2} {r}^{2}}} \qquad Equation 1$$

where Z_{conic} is the sag of a conic surface; c is the curvature of said surface; k the conic constant; and r a radial coordinate. If k=0, then the surface would be spherical.

z(r)=z_{conic}(r)+α₁r²+α₂r⁴+α₃r⁶+α₄r⁸+α₅r¹⁰ Equation 2

where each αₙ is a coefficient term corresponding to a given polynomial term.

It will be appreciated that Equation 2 includes a conic term and even-powered polynomial terms. It will also be appreciated that z (r) in each of Equations 1 and 2 will vary as a function of angular direction of a radius r. In some embodiments of the present invention, at least one of the αₙ terms is non-zero. It will be understood that it is typically desirable that the number of αₙ terms selected to be non-zero be the minimum necessary to achieve a selected performance and the magnitude of each αₙ be as small as possible. By so controlling the number and magnitude of said terms, sensitivity to decentration of the lens on the eye can be reduced, and manufacturability and testing of lenses can be simplified.

It will also be appreciated that, in some embodiments, lenses include surfaces having only even-powered aspheric terms. It is further to be appreciated that, although even-powered polynomial terms may be all that are necessary to achieve selected aberration performance, for some embodiments, odd-powered polynomial terms may be added. For example, odd-powered aspheric terms may be appropriately used to compensate for lens decentration on eye.

The curvature of anterior central zone 21 is selected such that anterior central zone 21, in combination with posterior central zone 11, provides a desired spherical power of the lens.

In the illustrated embodiment, the anterior surface is spherical and the lens is configured with a biconic surface on the posterior surface (i.e., on the toric surface) to achieve a suitable amount of spherical aberration in both meridians for an optical zone of a diameter of 6 mm. In other embodiments in which a toric surface is located on the posterior surface, a biconic surface may be located only on the anterior surface. It will be appreciated that if the biconic surface is placed only on a surface opposite toric surface, the lens will have two non-spherical surfaces. In some embodiments, such a configuration may be undesirable due, for example, to manufacturing complications associated with having two complex surfaces.

It is to be appreciated that although the illustrated lens has a posterior surface that is toric, according to aspects of the present invention, the anterior and/or posterior surfaces may be toric. The diameter of the optical zone (i.e., the diameter over which a suitable amount of aberration is to be achieved) is typically between 6-9 mm.

In some embodiments, both a toric surface and a non-toric (i.e., axisymmetric) surface have aspheric components. In some embodiments, a non-toric surface can be selected to be aspheric so as to provide a suitable amount of spherical aberration in a first meridian, and an aspheric term can be provided in a second meridian by the toric surface, such that the surfaces combine to achieve a suitable amount of spherical aberration in both meridians. In such embodiments, the toric surface may be aspheric or spheric in the first meridian.

Also, as described above, toric contact lenses are provided with a stabilization structure so that the lenses maintain a desired rotational orientation on the eye. For example, lens 1 may include a prism ballast 25 wherein peripheral section 24 has a different thickness than an opposed peripheral section including ballast 25 of the lens periphery. (Ballast 25 is at a “bottom” portion of the lens, since, when this type of toric lens is placed on the eye, the prism ballast is located downwardly.) The ballast is oriented along a meridian, referred to herein as the “ballast meridian.” As discussed above, toric contact lens prescriptions define an offset of the ballast axis from the sphere power meridian of the toric zone by a selected angle. The term “offset” is inclusive of angles of 0 degrees or 180 degrees, which describe lenses in which the sphere power meridian is coincident with the ballast axis.

Having thus described the inventive concepts and a number of exemplary embodiments, it will be apparent to those skilled in the art that the invention may be implemented in various ways, and that modifications and improvements will readily occur to such persons. Thus, the embodiments are not intended to be limiting and presented by way of example only. The invention is limited only as required by the following claims and equivalents thereto.

What is claimed is:

1. A contact lens, comprising:
a first surface; and
a toric second surface having a first meridian and a second meridian, the toric surface having a first aspheric component in the first meridian, and at least one of the first surface and the second meridian of the second surface having a second aspheric component, such that spherical aberration in the first meridian is within 0.1 microns (um) of being equal to the spherical aberration in the second meridian.

2. The contact lens of claim 1, wherein the spherical aberration in the first meridian and the spherical aberration in the second meridian are both between −0.35 to +0.35 um for light having a wavelength of 555 nm for an aperture of 6.0 mm.

3. The contact lens of claim 1, wherein the spherical aberration in the first meridian and the spherical aberration in the second meridian are both between 0.00 to −0.30 um for light having a wavelength of 555 nm for an aperture of 6.0 mm.

4. The contact lens of claim 1, wherein the spherical aberration in the first meridian and the spherical aberration in the second meridian are both between −0.05 to −0.25 um for light having a wavelength of 555 nm for an aperture of 6.0 mm.

5. The contact lens of claim 1, wherein the spherical aberration in the first meridian and the spherical aberration are both negative for light having a wavelength of 555 nm for an aperture of 6.0 mm.

6. The contact lens of claim 1, wherein the first meridian is a sphere power meridian and the second meridian is the cylinder power meridian.

7. The contact lens of claim 1, wherein the second surface is conic in the first meridian and in the second meridian.

8. The contact lens of claim 1, wherein the first surface is an anterior surface of the lens.

8. The contact lens of claim 1, wherein the first meridian and the second meridian are separated by 90 degrees.

9. The contact lens of claim 1, wherein the second surface is aspheric in the first meridian and in the second meridian.

10. The contact lens of claim 1, wherein the second meridian of the second surface is aspheric and the first surface is spherical.

11. The contact lens of claim 1, wherein the second meridian of the second surface is spherical and the first surface is aspheric.

12. The contact lens of claim 1, wherein the first surface is axisymmetric.
